(19) United States
(12) Patent Application Publication
(10) Pub. No.: US 2005/0222899 A1
(43) Pub. Date: Oct. 6, 2005

(54) System and method for skill managememt of knowledge workers in a software industry

(75) Inventors: Sridhar Varadarajan, Bangalore (IN); Korrapati Kalyana Rao, Bangalore (IN)

Correspondence Address: Richard L. Byrne, 700 Koppers Building, 436 Seventh Avenue, Pittsburgh, PA, 15219-1818, US

(73) Assignee: SATYAM COMPUTER SERVICES INC.

(21) Appl. No.: 10/813,844

(22) Filed: Mar. 31, 2004

(51) Int. Cl. G06F 17/60

(52) U.S. Cl. 705/11; 705/1; 705/9

(57) ABSTRACT

Workforce management enables enterprises to obtain best return on investment on workforce. Human capital forms a major investment in software services companies and effective management of these human resources has a greater impact on the overall profitability of such companies. Manual approaches for workforce management may lead to less optimal utilization of resources. A system for skill management of knowledge workers involves (a) obtaining the skills of a resource on joining; and (b) tracking the skill enhancements and additional skills acquired by the resource subsequently. The factors that largely affect the skills of a resource are qualification of the resource, trainings undergone by the resource, and projects executed by the resource. These aspects are represented using a common dictionary describing software development processes and relevant domains. Such a representation and an up-to-date skill information enables a near-optimal allocation of right resources to meet the requirements of new projects. An overall network based skill management system comprising a plurality of interconnected local skill management systems with a central skill manager helps in achieving a near-optimal utilization of resources distributed geographically.

### FIELD OF THE INVENTION

The present invention relates to the management of resources of an enterprise in general, and more particularly, skill management of human resources. Still more particularly, the present invention relates to a system and method for skill management of knowledge workers in a software industry by continuous tracking of skills obtained by knowledge workers and using the up-to-date skill information to allocate right knowledge workers to meet project requirements.

### BACKGROUND OF THE INVENTION

Workforce management is an important aspect of an enterprise. For example, sales force automation involves the management of sales personnel from the point of view of maximizing return on investment on these personnel. Typically, this involves providing support for carrying out the various activities such as sales, order processing, order tracking, and customer interaction. Software services companies are relatively human capital based and require the management of the human resources, or alternatively knowledge workers, to have a good control over the companies' businesses. A software services company typically provides software development services wherein the company executes several software development projects for its clients. In order to help easily execute projects, the company has well defined software development processes that provide adequate steps to execute the various kinds of projects. Further, a project has a well defined project plan that identifies a number of work items with inter-dependencies and each work item has a distinct start date, end date, and the number of resources with a specific skill required to execute the work item. In order to successfully complete the project, it is essential that the right resources are allocated to the project at the right time so that the project gets started on time and gets completed as scheduled. Normally, resources have multiple skills and a work item of a project requires a particular skill so that the assigned resources specialized in that skill can carry out the work efficiently and effectively.

It is necessary to track the skills of resources as they get assigned to various projects so that skill information is up-to-date. This helps in allocating the most appropriate resources to newer projects. The tracking of the acquired additional skills is done during the execution of a project either implicitly or explicitly. Implicitly, the collected metrics such as number of design bugs, number of program compilation errors, and number of logical errors in a program provide some insight into the proficiency in a particular skill. Explicitly, the project end appraisals by a project manager provide some additional information about the overall proficiency. Taking into account these factors, it is appropriate to normalize the skill grades over several project executions so that the selection of a resource for a particular project based on the grade of skills is effective.

Automating the various activities of Skill Management subsystem of Workforce Management of a software services company requires a parsimonious representation of skills of the human resources of the company and skills required to execute the work items of the various projects executed by the company. Such an automation would help the company to manage its most costly investment and achieve the best return on investment. Furthermore, assigning right resources to right projects would help create specialists as they get assigned to similar projects and this is best both from projects and resources points of view: from the project point of view, the right resource achieves the requirements of an assigned work item with a least number of errors, while from the resource point of view, the right project has an impact on the morale as it avoids frequent reskilling.

### DESCRIPTION OF RELATED ART

U.S. Pat. No. 5,911,134 to Castonguay; Ronald M. (Carrollton, Tex.); Crockett; Gary B. (Plano, Tex.) for “Method for planning, scheduling and managing personnel” (issued on Jun. 8, 1999 and assigned to IEX Corporation (Richardson, Tex.) describes a method for planning, scheduling, and managing personnel based on forecasted load and templates describing bounded work shift having work rules and operating constraints.

U.S. Pat. No. 6,424,709 to Doyle; Robert J. (Newbury Park, Calif.); Sunderman; Kurt E. (Geneva, Ill.) for “Skill-based call routing” (issued on Jul. 23, 2002 and assigned to Rockwell Electronic Commerce Corp. (Wood Dale, Ill.)) describes a method for assigning agents to incoming calls based on required qualifications and skill level of the agents.

U.S. Pat. No. 6,574,605 to Sanders; Barbara (Canyon Lake, Tex.); Robb; Curtis (Hagerstown, Md.); Gau; Jet (Hagerstown, Md.) for “Method and system for strategic services enterprise workload management” (issued on Jun. 3, 2003 and assigned to Citibank, N.A. (New York, N.Y.)) describes a system and method for enterprise workload management that enables an organization such as financial institution to route any channel service to customer service representatives in such a way that both customers' intent and organization's intent are satisfied.

U.S. Pat. No. 6,606,480 to L'Allier; James J. (Batavia, Ill.); Pezzuti; Albert (Linthicum, MD); Henrie; Stephen P. (Woodridge, Ill.) for “Automated system and method for creating an individualized learning program” (issued on Aug. 12, 2003 and assigned to National Education Training Group, Inc. (Chestnut Hill, Mass.)) describes a method that identifies a gap between the skills possessed by individuals and those required by an organization, and creates a training regimen to fill that gap.

The known systems do not address the issue of skill management of knowledge workers to achieve a near-optimal assignment of resources to meet projects' requirements. The present invention provides with a system for tracking the skills acquired by resources over a period of time. Further, the present invention provides for selecting the near-best possible resources to meet the requirements of a project based on a divide-and-conquer approach.

### SUMMARY OF THE INVENTION

The primary objective of the invention is to achieve the skill management of resources within a software services company. This is achieved by continuously tracking the skills of the resources and using a divide-and-conquer approach to assign the near-best possible resources to meet the requirements of projects.

One aspect of the present invention is the management of qualification, resume, and project information, wherein skill organizer manages information related to basic skills from qualification, and information related to advanced skills from resume and project information.

Another aspect of the present invention is the parsimonious representation of skills of resources and skills demanded in project plans using a common hierarchical representation derived from software development processes and information from relevant domains.

Yet another aspect of the present invention is basic skill assessment wherein different basic skills are defined based on software development processes and information form relevant domains, and skill assessment is based on (a) a set of rules that define a mapping of qualification, field of study, and interview test results to skill types, and (b) a set of functions that compute proficiency in basic skills.

Another aspect of the present invention is advanced skill assessment wherein different advanced skills are defined based on software development processes and information from relevant domains, and skill assessment is based on (a) project related experiences in multiple major areas and fields of work, and (b) external references.

Yet another aspect of the present invention is skill evolution wherein assessment of additional skills is based on (a) individual project experiences, and (b) various training programs.

Another aspect of the present invention is skill matching wherein a near-best possible available resources are identified to meet the skill requirements of a project.

Another aspect of the present invention is an overall network based skill management system with a plurality of local skill management systems and a central skill manager.

Yet another aspect of the present invention is distributed processing of resource requirements.

### BRIEF DESCRIPTION OF THE DRAWINGS

FIG. 1 depicts the architecture of Skill Management System (SMS) along with the main components.

FIG. 2 depicts the key elements of SMS system.

FIG. 3 provides a description of the different kinds of skills.

FIG. 4 depicts the typical workflow of SMS system.

FIG. 5 provides a brief description of the various databases of SMS system.

FIG. 6 describes the procedure related to Qualification management.

FIG. 7 describes the procedure related to Resume management.

FIG. 8 describes the procedure related to Project information management.

FIG. 9 describes the procedure related to the assessment of basic skills of resources.

FIG. 10 describes the procedure related to the assessment of advanced skills of resources.

FIG. 11 describes the procedure related to the evolution of skills of resources.

FIG. 12 describes the various aspects of skill matching to select resources based on a given set of skills.

FIG. 13 describes the procedure for iterative skill matching to achieve a near-best possible resource selection.

FIG. 14 describes the procedure for optimal assignment of resources.

FIG. 15 depicts the architecture of a network based system involving multiple SMSs.

FIG. 16 describes the procedure for distributed processing of resource requirements.

### DETAILED DESCRIPTION OF THE PREFERRED EMBODIMENTS

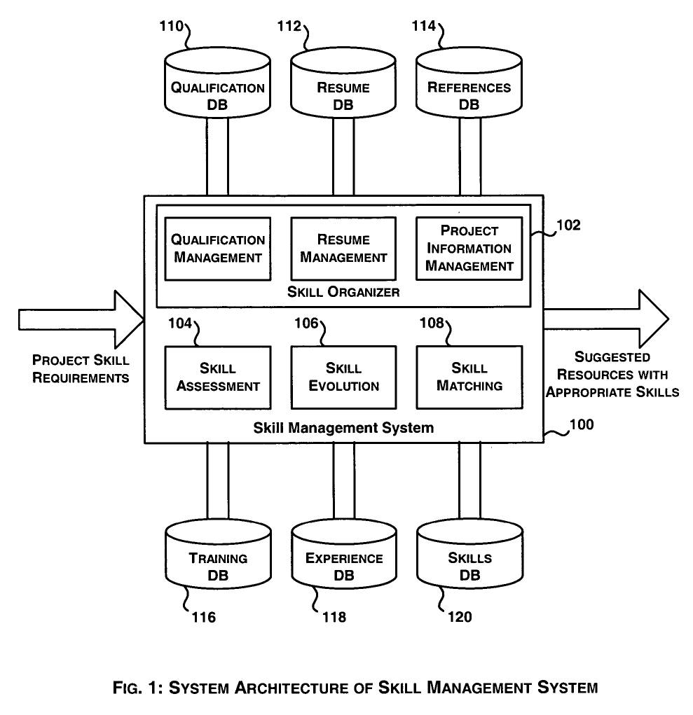

FIG. 1 depicts the system architecture of Skill Management System (SMS) (100) consisting of Skill Organizer (102), Skill Assessment (104), Skill Evolution (106), and Skill Matching (108) subsystems. The main objectives of SMS system, in the context of a software services company, are to (a) evaluate the skills of resources when they are inducted into the company; (b) continuously track the skills of the resources as they work on various projects and undergo various trainings; and (c) identify the most suitable available resources to meet the skill requirements of a project. A software services company executes multiple projects for each of its clients and each such project has (a) well defined start and end dates; and (b) a project plan identifying the various work items that need to be undertaken at various time periods so that the project gets completed as scheduled. A typical software services company has a well defined, certified software development process that enables the company to effectively execute projects. The process provides adequate vocabulary to describe the work items in a project plan and also defines the skills required to execute the work items. Hence, a project plan identifies the number of resources with required skills at various time periods and in order to start and complete the project on time, the resources with the required skills need to be assigned to the project. Resources have multiple skills acquired both through training and through on job, and over a period of time get assigned to multiple projects. Further, under certain situations, resources with skills matching exactly with the required skills may not be available. In other words, a resource with a skill nearest to the required skill (as provided in a project plan) available only for a portion of the time period (as provided in the project plan) may only be available. To account for these factors, the process of selection of resources need to identify the best possible resources available for the best portion of the project work item period. Resources are inducting to the company, by and large, through two means: trainee engineers (entry level) and experienced engineers (lateral recruitment). While the qualification of the entry level resources play an important role in assessing the basic skills, on job experience provides information about advanced skills.

Skill Organizer (102) maintains multiple databases to help track the skills of the resources. Qualification DB (110) contains information related to qualification of the resources and is used to assess basic skills of the resources. Resume DB (112) contains information related to on job experiences of the resources and References DB (114) provides information about proficiency of the resources in various skills, and are useful in assessing advanced skills of the resources. Training DB (116) captures information related to additional skills acquired by the resources through training while Experience DB (118) contains information related to the various projects executed by the resources and are used to assess advances skills of the resources. These databases are used to assess the skills of the resources on induction into the company (104) and are continuously tracked (106) and skill grades of the resources are maintained in Skills DB (120). On launch of a new project, the skills required to successfully execute the project are determined and are used to select the most suitable resources (108).

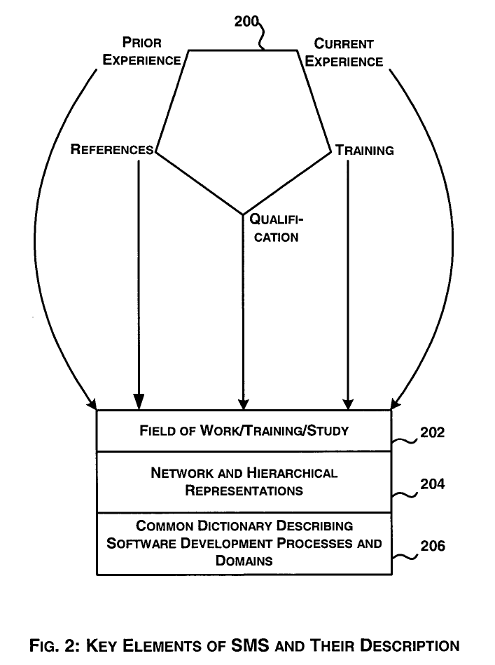

FIG. 2 provides a brief description of the various key elements of SMS system. The system is based on five elements (200), namely, Qualification, References, Training, Prior Project Experience, and Current Project Experience. It is essential to represent these elements for various resources in such a way that the required skill assessment and skill matching can be efficiently undertaken. Any training or experience is in a particular field and a particular area (202), and the information related to work, training, and study is represented using network and hierarchical structures (204). A common dictionary (206) with entities defined based on software development processes and domain knowledge is used to represent information that is required to manage the skills of the resources.

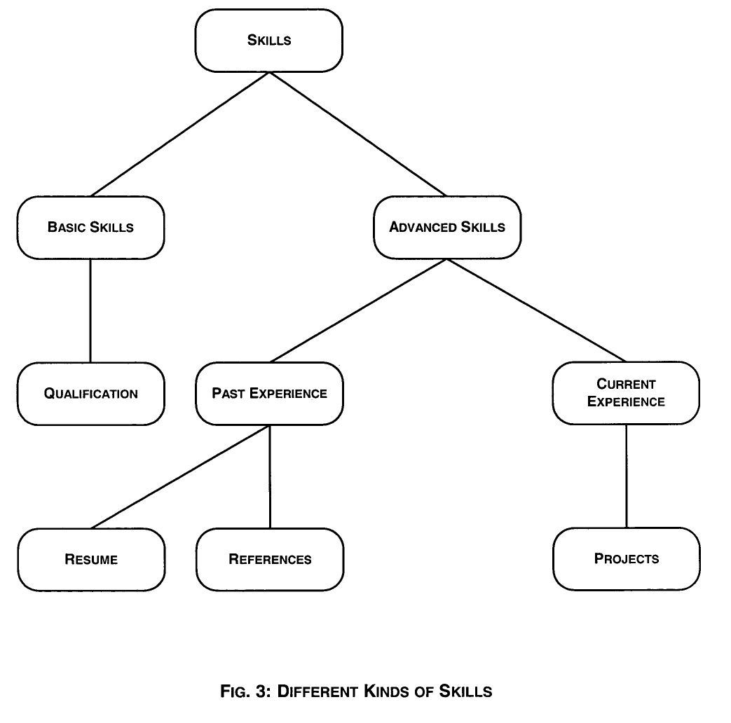

FIG. 3 describes the different kinds of skills. Basic skill is assessed based on qualification while advanced skill is assessed from the past and current project based experiences. The information related to past experience is obtained from resume and references while the information related to current experience is obtained from project plan, project review reports, end of project appraisals, and project metrics.

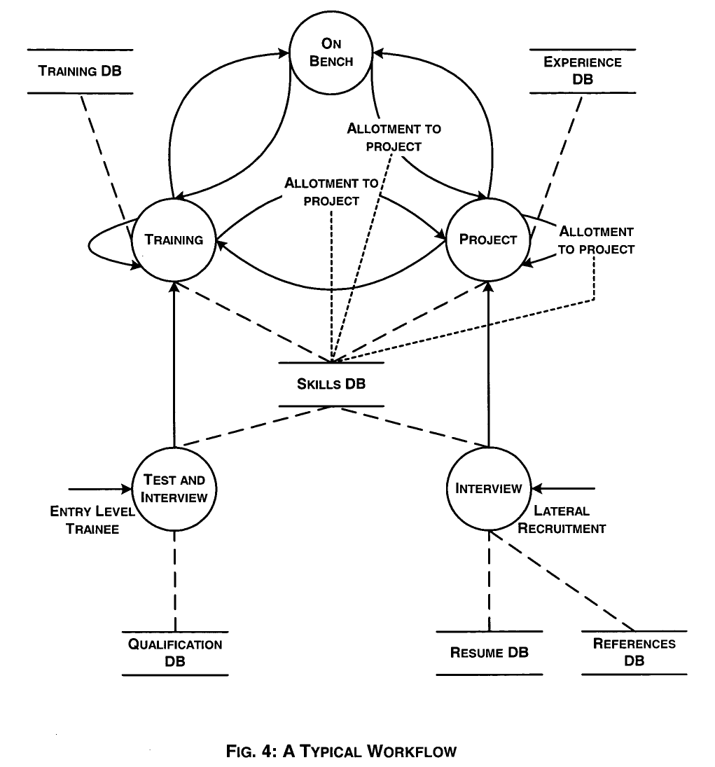

FIG. 4 describes a typical workflow related to SMS system. The workflow depicts the major functions of the system and indicates the process of updation and use of Skills DB.

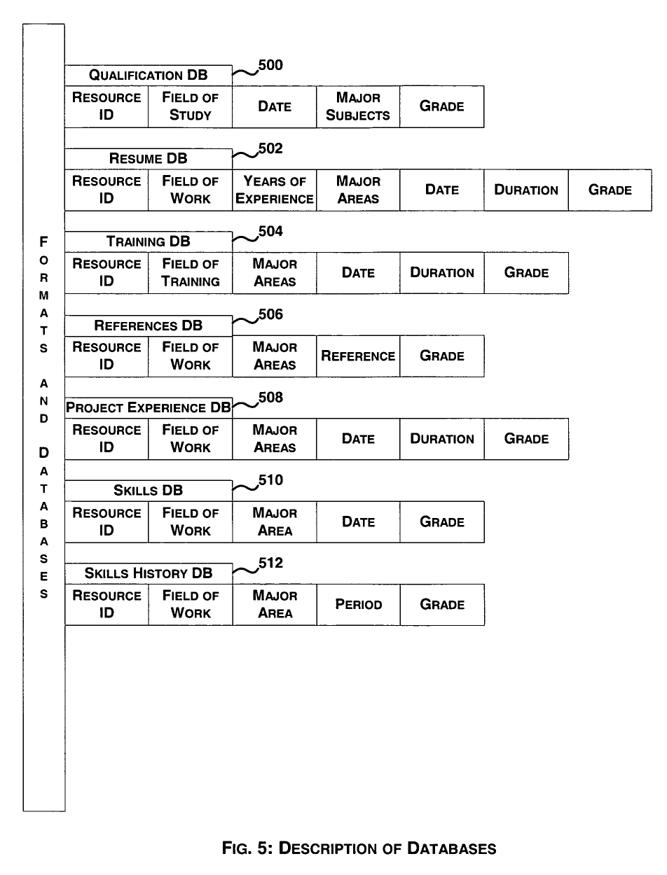

FIG. 5 provides a brief description of a few important elements of some of the databases of SMS system. 500 represents Qualification DB and consists of information such as field of study and grade. 502 represents Resume DB and consists of information related to various job related experiences in a variety of areas. 504 depicts information related to Training DB and consists of information such as field of training and the obtained grade. 506 relates to References DB and consists of information such as areas of reference and the associated evaluation. 508 relates to project based experience information and consists of information such as areas of work and the evaluation results. 510 provides information related to the various skills of resources and 512 contains skills history information along with evaluation for trending purposes.

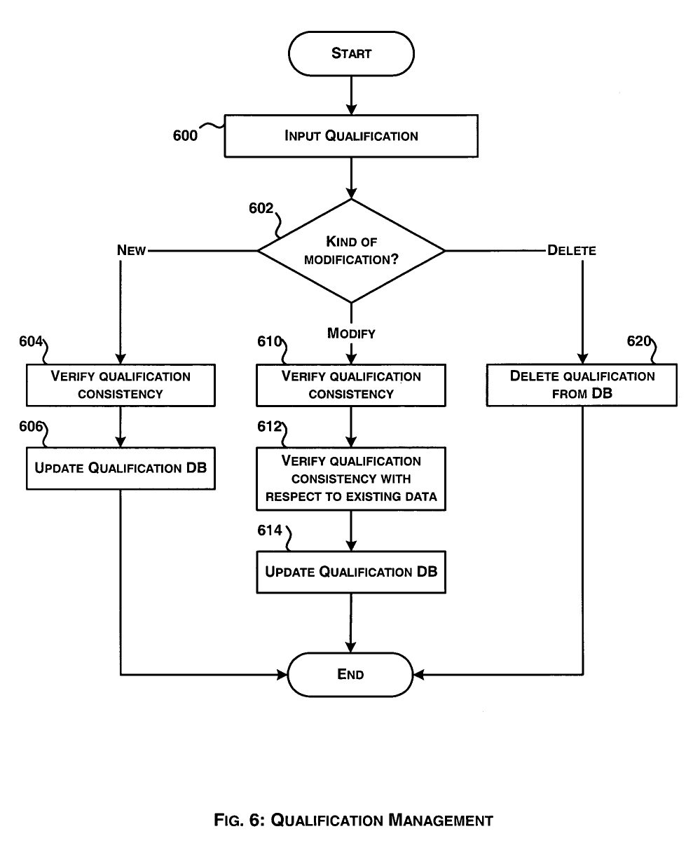

FIG. 6 describes the procedure related to qualification management. Qualification forms one of the important inputs (600) to SMS system and it is appropriate to expect that the consistent qualification information is stored in Qualification DB. The resume associated with a resource contains qualification information and its consistency across the information contained in the resume is checked and appropriate exception reports are generated in the case of a new input (604) and consistent information is used to update the database (606). In the case of an update to an existing information (602), the information is verified not only with respect to the rest of the input information (610) but also with respect to the information already present in the database (612). The consistent information is updated onto the database (614). On the other hand, if the request is to delete certain qualification information (602), the database is suitably updated (620).

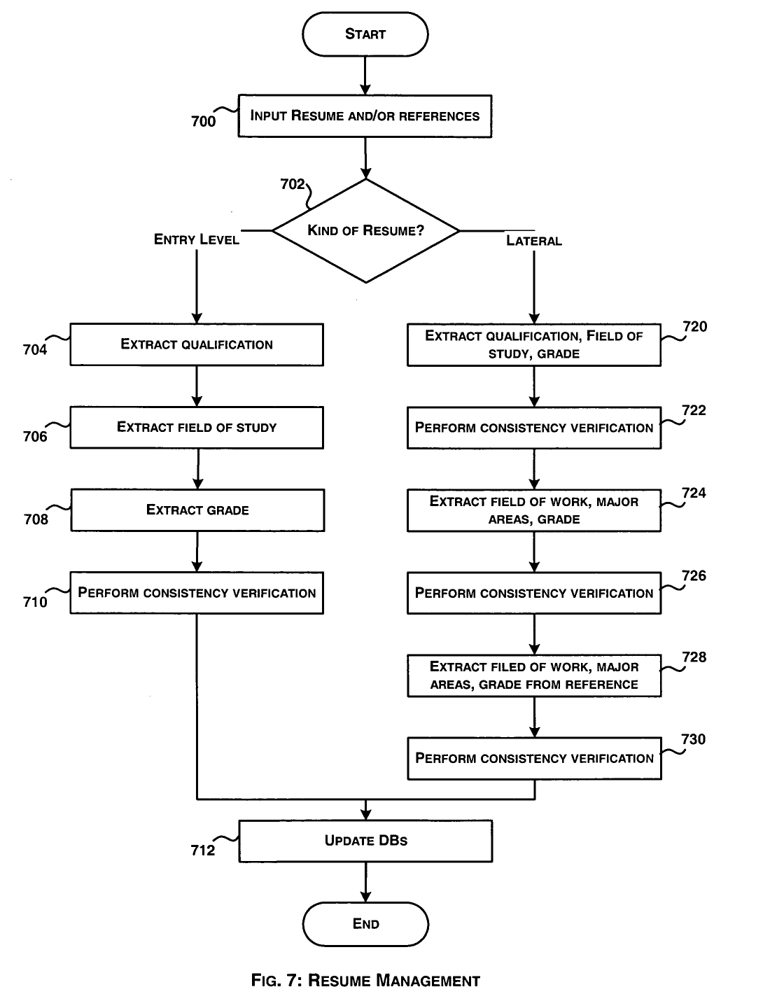

FIG. 7 describes the procedure related to resume and reference management. The input resume is analyzed and the nature of resume is determined (700). If the kind of resume is related to an entry level resource (702), then the qualification (704), field of study (706), and the obtained grade (708) are extracted. The extracted information is analyzed for mutual consistency (710) and the database is appropriately updated (712). On the other hand, if the resume is related to an experienced resource (702), then the qualification, field of study, and the obtained grade are extracted (720), and their mutual consistency is verified (722). Further, the field of work, major areas, and the obtained grade are extracted from the resume (724), and their mutual consistency and consistency with respect to the qualification are verified (726). If a reference is also provided as input (700), then the information related to the various project experiences along with the obtained grade are extracted (728) and consistency verification with respect to the resume data is performed (730). Finally, the database is appropriately updated (712).

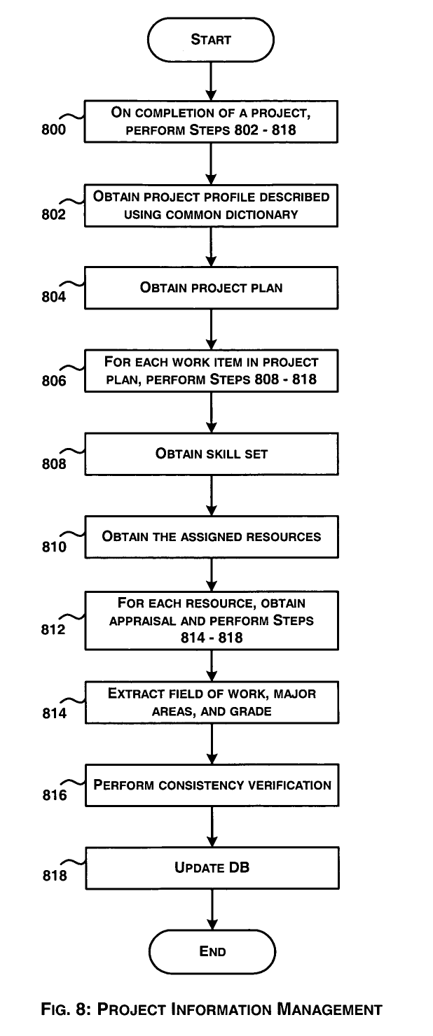

FIG. 8 describes the procedure related to the project information management. A project plan of a completed project consists of the various resources that worked on the project on various work items that required certain skills. Based on the software development process, at the end of a milestone, as identified in the project plan, appraisals are undertaken to evaluate the efficiency and productivity of the various resources with respect to their assigned work items. This forms an important input in assessing the skill levels of the resources. On completion of a project, perform Steps 802 through 818 (800). Obtain the project related information such as the nature of project and the domain information described using a common dictionary (802). Obtain project plan of the project (804) and for each work item in the project plan, perform Steps 808 through 818 (806). Obtain necessary skills required to execute a work item and this provides adequate information as to the skills acquired by the resources who executed the work item successfully (808). Obtain resource worked on the work item (810). For each resource, obtain the project end appraisals and perform Steps 814 through 818 (812). Extract the field of work, major area, and the obtained grade, based on project profile, work item, appraisals, and project metrics (814) and perform consistency verification to generate exception reports (816). Finally, update the database appropriately (818).

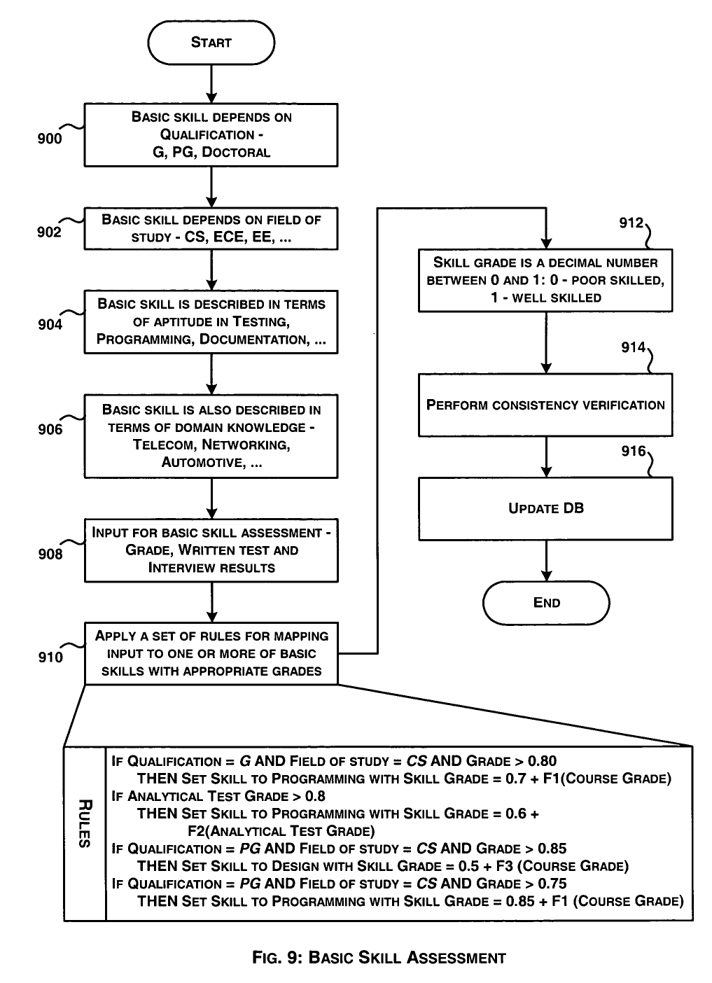

FIG. 9 describes the procedure for the assessment of basic skills. Basic skill depends on qualification, namely, whether a particular resource is a graduate, postgraduate, or has a doctoral degree (900). Further, the basic skill also depends on field of study, namely, Computer Science, or Electronics and Communication Engineering (902). Typically, basic skills are described in terms the level of aptitude in activities such as Testing, Programming, or Documentation (904) and where appropriate, especially in the cases of postgraduates and doctoral degree holders, expertise in various domains such as telecom, networking, and automotive are also assessed (906). Taking into consideration the above mentioned aspects, the input for basic skill assessment is the grade obtained in degree examinations, written test, and interview results (908). A set of predefined rules are applied to map the input to one or more basic skills with appropriate grades (910). In order to have a flexibility in assessment, the skill grades are a decimal number between 0 and 1 with 0 indicating a low skill profile and 1 indicating a high skill profile (912). After the assessment of basic skills, a consistency check is performed to ensure that the assessed skill levels match to an adequate extent with respect to the qualification and grade (914). Finally, the database is suitably updated (916).

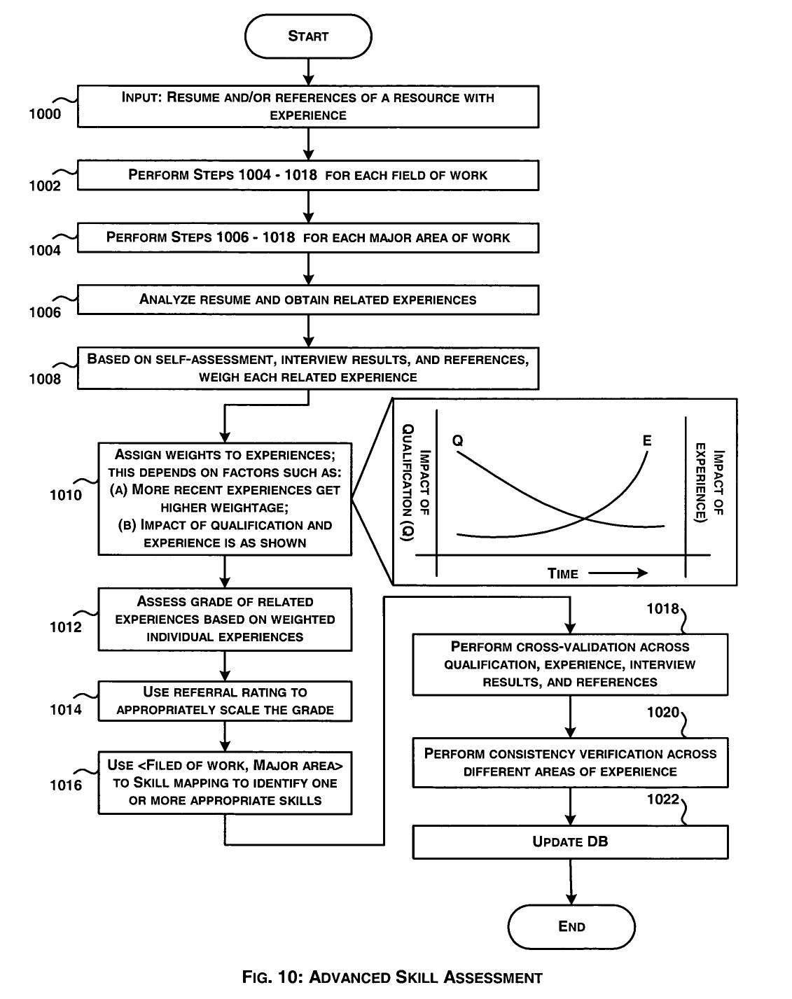

FIG. 10 describes the procedure for the assessment of advanced skills. Input for such an assessment is resume and/or references of a resource (1000). Perform Steps 1004 through 1018 for each field of work in which the resource has related experiences (1002). For each major area of work under the field of work, perform Steps 1006 through 1018 (1004). Analyze the resume and obtain the related experiences of the resource in the major area of work (1006). Based on self-assessment, interview results, and references, weigh each of the related experiences (1008). Assign weights to each such experience (1010). Typically, weight determination depends on factors such as (a) assign a higher weight to a more recent experience; and (b) impact of qualification reduces with time. Assess the grade of related experiences based on weight associated with each related experience (1012). Use referral rating to appropriately scale the assessed grade (1014). Use a mapping function to map <field of work, major area of work> to one or more appropriate skills (1016). Perform cross-validation across qualification, experience, and assessed grade to generate exception reports under inconsistent conditions (1018). Perform consistency validation across different areas of experience to ensure that overall skill assessment is in order (1020). Finally, the database is suitably updated (1022).

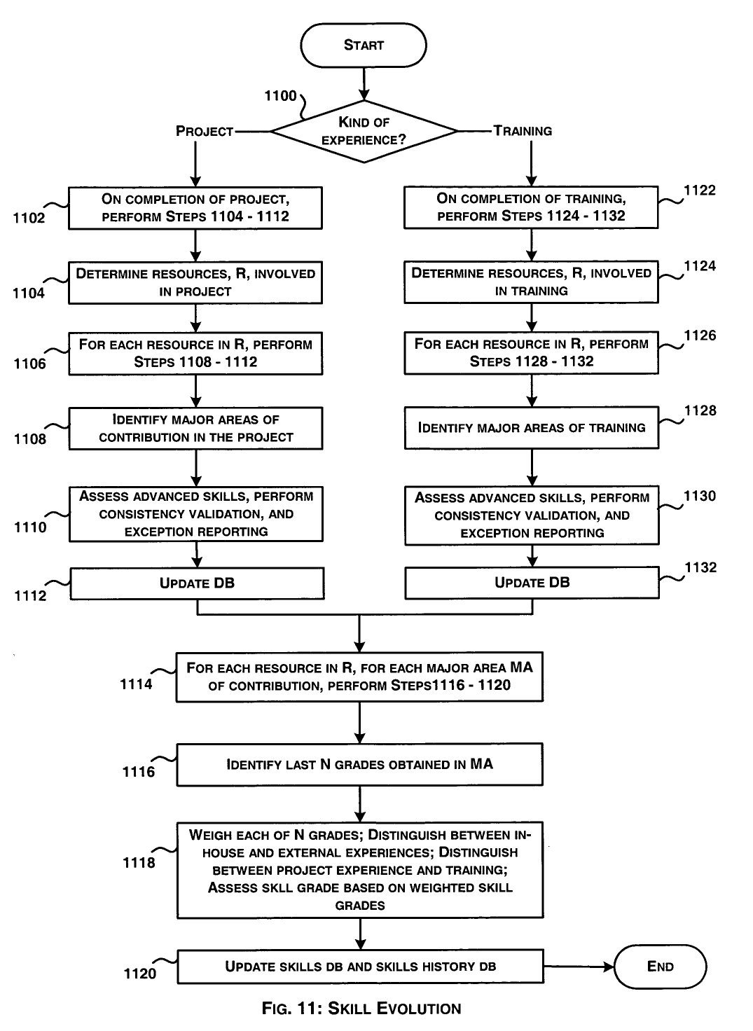

FIG. 11 describes the procedure for evolving the skills of resources. Skill evolution is based on project and training experiences (1100). If the nature of experience is a project related experience, perform Steps 1104 through 1112 (1102) and determine the resources involved in the project (1104). For each resource, perform Steps 1108 through 1112 (1106). Identify the major areas of contribution in the project (1108). Assess advanced skills based on project metrics and project end appraisals associated with the resource, perform consistency validation, and report exception (1110) and update database (1112). For each resource and for each major area of contribution, perform Steps 1116 through 1120 (1114). Identify the last N skill grades for the selected major area (1116). Weigh each of the N grades, distinguish between in-house and external experiences, and distinguish between training and project experiences; assess skill grade based on these weighted skill grades (1118). Update skills database and skills history database (1120). On the other hand, on completion of a training program, perform Steps 1124 through 1132 (1122). Determine resources involved in the training program (1124). For each resource, perform Steps 1128 through 1132 (1126). Identify the major areas of training (1128). Assess advanced skills acquired by the resource based on training metrics and training end appraisals associated with the resource, perform consistency verification, and generate exception reports (1130), and update database (1132). Perform Steps 1114 through 1120 to assess the skill grades of the resources.

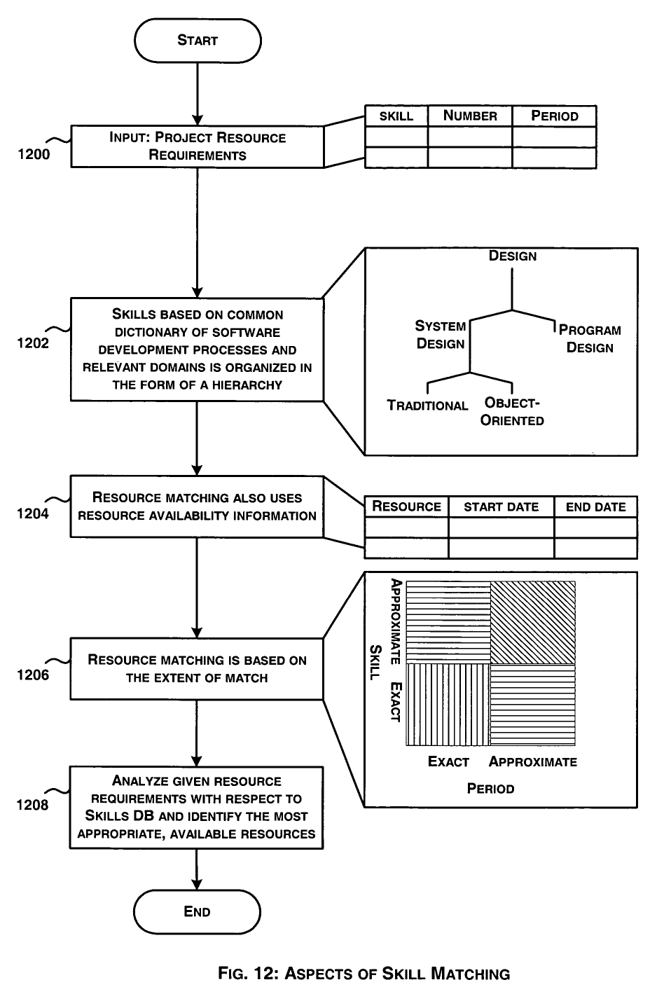

FIG. 12 describes the various aspects of skill matching. On launch of a project, it is required to assign resources with right skills so that the project gets started and completed on time. This requires determining the various skills required at various time periods during the course of the project and ensuing that right resources are identified. The identified resources need to be available throughout the period and any partial availability needs to be addressed as well. On account of these factors, many combination of resources are feasible leading to the need to determine the best possible combination. The input is the project resource requirements (1200). This specifically consists of the nature of skill, number of resources required with that skill, and the period during which the resources are required. Skills are described based on a common dictionary of software development processes and relevant domains, and is usually organized in the form of a hierarchy (1202). Such a hierarchical relationship helps discover resources with nearest skills in cases when the resources with exact skills are not available and the notion of nearness is based on the distance between two skills that is based on the path length between the two corresponding nodes in the hierarchy. Resource availability forms another factor in the resource matching process (1204) and resource availability is described in terms of periods during which resources have been assigned for work items of various projects. Considering the nature of skill and the availability of a particular resource, four distinct kinds of matching is possible (1206). With respect to the requirements, the matching is exact when a resource with exact skills is available for the entire duration of the needed period and is approximate when only a nearest skill is available for a partial period. The other two semi-exact cases are either when an exact skill is available only for a partial period or when a resource with only a nearest skill is available for the entire period. The process of resource selection accounts for all these four cases in which the given resource requirements are analyzed with respect to skills database and the most appropriate, available resources are identified (1208).

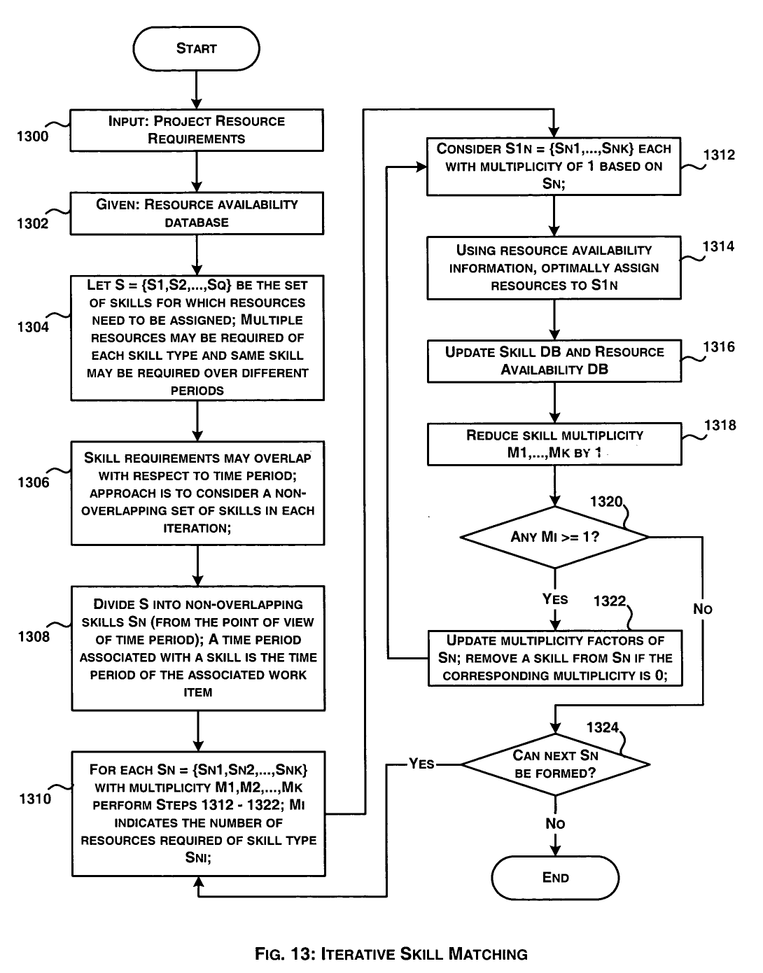

FIG. 13 describes the procedure for iterative skill matching. The input for skill matching is the resource requirements of a project described in terms of skills (1300). The procedure makes use of resource availability database to determine the availability of various resources with respect to the time periods depicted in the project resource requirements (1302). Let S={S1, S2, . . . , Sq} be the set of skills for which resources are required to be assigned. A project plan provides start date, end date, nature of skill, and the number of resources required for each work item. Further, note that multiple resources with same skill may be required and the same skill may be required over different time periods (1304). The various work items in a project plan may overlap with respect to time periods and hence, the skills required to carry out these work items also overlap. The approach is to iteratively address a set of work items of a project plan that do not overlap from the point of view of time periods associated with the work items of the set, and assign resources required to meet the skill requirements of these work items (1306). Divide the work items of a project into a set of non-overlapping work items. Specifically, work items of a set are non-overlapping if no two work items get executed within an overlapping time period. Form the corresponding set of skills based on the skill requirements of each of the work items of the set (1308). For each such non-overlapping skill set, perform Steps 1312 through 1322 related to the assignment of resources to meet the skill requirements of work items (1310). Let Sn={Sn1, Sn2, . . . ,Snk} be such a skill set and let M1, M2, . . . ,Mk be the multiplicity factors depicting the number of resources required with skills Sn 1, Sn2, . . . ,Snk respectively. In order to solve the resource assignment problem with a certain degree of flexibility, the assignment of resources to meet the skill requirements with respect to Sn is addressed by considering the skill requirements, with a multiplicity factor of 1, iteratively (1312). Let S1n be a subset of Sn such that multiplicity factor of each skill in S1n is 1. Using the resource availability information, optimally assign resource to meet S1n requirements (1314). Update skill database and resource availability database (1316). Reduce the skill multiplicity factors of skills in Sn by 1 (1318) and check whether any of the multiplicity factors is still greater than or equal to 1 (1320). If so, form a new skill set Sn, with respective multiplicity factors reduced by 1 and removing those skills whose multiplicity factors have become 0 (1322) and repeat Steps 1312 through 1320. On the other hand, if no Mi is greater than 0 (1320), then check whether a new Sn with non-overlapping skill requirements can be formed (1324). If so, repeat Steps 1310 through 1322.

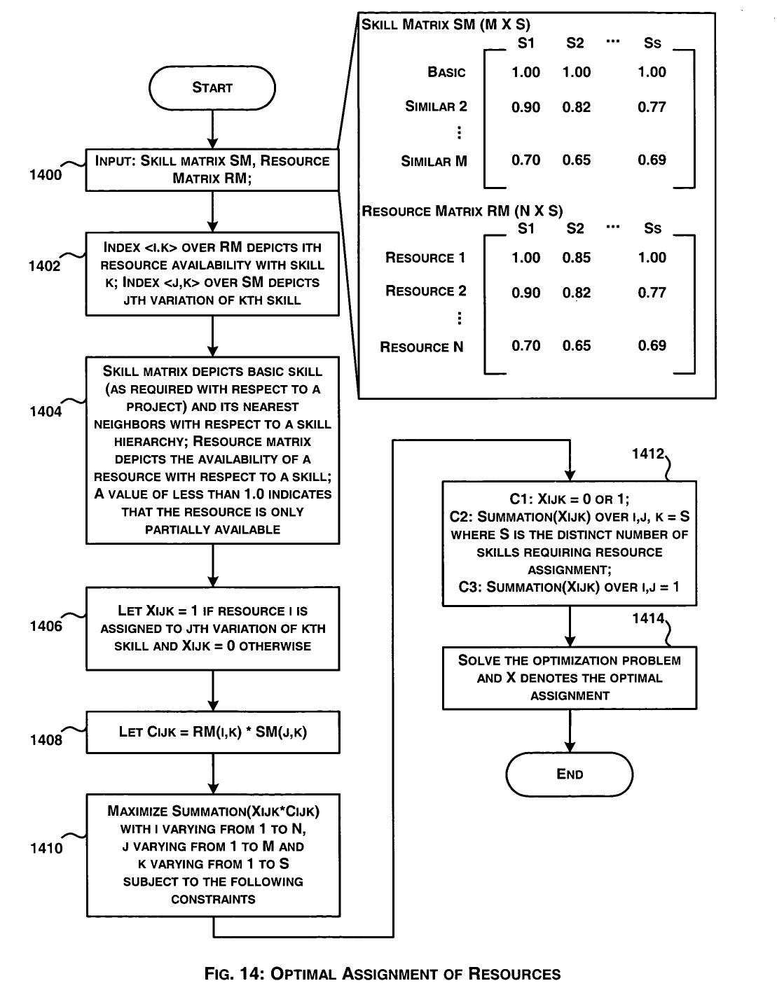

FIG. 14 describes the procedure for optimal assignment of resources to meet the input skill requirements. The inputs to the procedure are (a) Skill Matrix, SM; and (b) Resource Matrix, RM (1400). S1, S2, . . . , Ss are the S skills for which resources are required to be assigned and SM consists of M variations of each of these S skills that can also meet the project requirements with some compromise. The extent of compromise is an evaluation between 0 and 1, and the values closer 1 to indicate the closeness in similarity between the two skills under consideration. SM matrix contains these evaluations. RM consists of the availability of N resources for periods over which S skills are required. The availability is indicated by a value between 0 and 1, the value equal to 1 indicates that the resource is available for the entire period and the value equal to 0 indicates that the resource is not available at all. Thus, RM (i,k) indicates the availability of ith resource to meet the requirements of kth skill and SM (j,k) indicates the similarity of jth variation of kth skill (1402). SM depicts the basic skill (as required with respect to a project) and its nearest neighbors with respect to a skill hierarchy and RM indicates resource availability (1404). Let X(i,j,k) be 1 if ith resource is assigned to jth variation of kth skill and be 0 otherwise (1406). Define the function C(i,j,k) as RM(i,k)*SM(j,k) that denotes the suitability of ith resource to meet kth skill requirement (1408). The objective function for optimization is defined as follows: Maximize (summation (X(i,j,k)*C(i,j,k)) (1410) subject to the following constraints (1412). Constraint C1: X(i,j,k) is either 0 or 1 which indicates that either a resource is assigned or not; Constraint C2: Summation (X(i,j,k)) over i,j,k is S where S is the total number of distinct skills requiring resource assignment; and Constraint C3 is Summation (X(i,j,k)) over i,j is 1 which indicates that only one resource gets assigned to meet kth skill requirement. In the above objective function and constraints, i varies from 1 to N, j varies from 1 to M, and k varies from 1 to S. Solve the defined optimization problem either using a classical approach or a stochastic approach and the matrix X denotes the optimal resource assignment (1414).

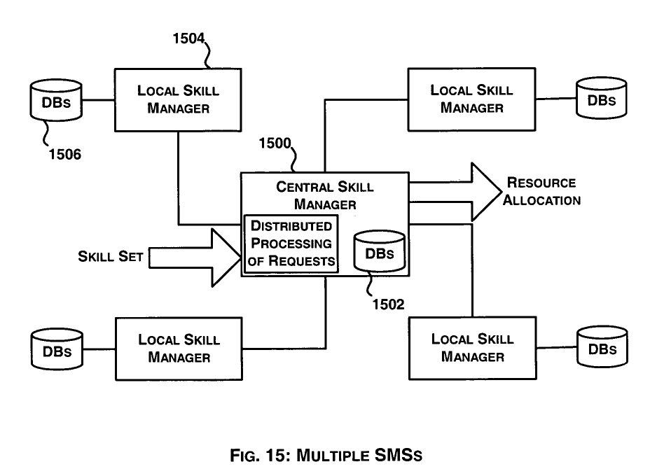

FIG. 15 describes the overall network based skill management. Central Skill Manager (1500) with appropriate distributed processing components and databases (1502) receives a set of resource requests with necessary skills to meet the requirements of a project. The databases consist of resource and skill information that are centrally managed, and also consist of information about multiple Local Skill Managers that are distributed over a network. Such a central skill manager is suitable for a company with several offices distributed geographically. The central skill manager interacts with multiple Local Skill Managers (1504) each with its own local database (1506) containing information about locally managed resources and their skills.

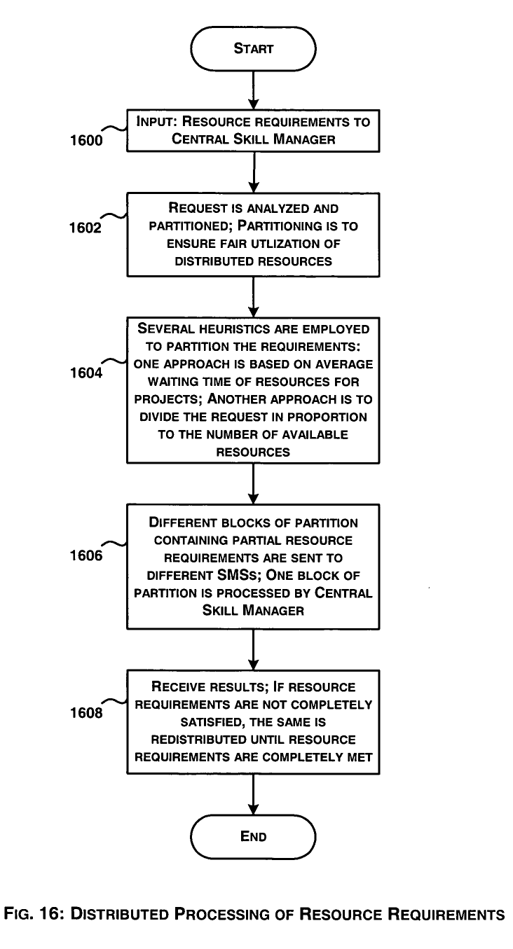

FIG. 16 describes the procedure for distributed processing of resource requirements. Central Skill Manager receives the resource requirements (1600). In order to process the requests in a distributed manner, the input requirements are partitioned into multiple blocks, each block containing a portion of the requirements (1602). Such a distribution ensures fair utilization of distributed resources. Several heuristics are employed to partition the requirements (1604). One approach is based on fairness policy in which the average waiting time of resources to get allocated to projects is about the same for all the resources. Alternatively, divide the request for resources to be distributed to multiple local skill managers based on the number of resources available in each of these SMSs. The divided blocks are sent to the various SMSs with one of the blocks being processed by the central skill manager (1606). The central skill manager receives the results from these SMSs and accumulates them to check if the request is met completely. If it is not so, the unsatisfied resources are partitioned and again distributed across multiple SMSs taking care that the same request is not sent more than once to the same SMS and Steps 1602 through 1606 are repeated until the input request is satisfied completely (1608).

Thus, a system and method for skill management of knowledge workers in a software industry and allocation of near-best possible resources to meet the requirements of a project has been disclosed. Although the present invention has been described particularly with reference to the figures, it will be apparent to one of the ordinary skill in the art that the present invention may appear in any number of systems that perform skill assessment and resource allocation based on the skills in the context of software services companies. It is further contemplated that many changes and modifications may be made by one of ordinary skill in the art without departing from the spirit and scope of the present invention.

1. A system for skill management of a plurality of knowledge workers in a software industry based on continuous tracking of skills obtained by said knowledge workers, said system comprising:
(a) a skill organizer subsystem for tracking of skills of said plurality of knowledge workers, said skill organizer comprising: a qualification management element for managing skills of said plurality of knowledge workers based on qualification; a resume management element for managing skills of said plurality of knowledge workers based on resume; and a project information management element for managing skills of said plurality of knowledge workers based on project information;
(b) a skill assessment subsystem for assessing skills of said plurality of knowledge workers;
(c) a skill evolution subsystem for incrementally updating skills of said plurality of knowledge workers;
(d) a skill matching subsystem for matching skills of said plurality of knowledge workers with respect to a set of requirements; and
(e) a skill representation subsystem for managing representation of a plurality of key elements of said system comprising qualification, resume, reference, past work experience, and current work experience.

2. The system of claim 1, wherein said qualification management element of said skill organizer subsystem comprises means for processing qualification information of a knowledge worker comprising consistency verification of qualification information of said knowledge worker, and consistency verification of qualification information with related information associated with said knowledge worker.

3. The system of claim 1, wherein said resume management element of said skill organizer subsystem comprises means for processing information contained in a resume of an entry level knowledge worker comprising extraction of qualification, field of study, and grade from said resume, and consistency verification of information contained in said resume of said entry level knowledge worker.

4. The system of claim 3, wherein said resume management element further comprises means for processing information contained in a resume of an experienced knowledge worker comprising extraction of qualification, field of study, and grade from said resume, extraction of field of work, major area, and grade related to a plurality of experiences of said experienced knowledge worker, extraction of field of work, major area, and grade from a plurality of references provided by said experienced knowledge worker, and consistency verification of information contained in said resume of said experienced knowledge worker.

5. The system of claim 1, wherein said project information management element of said skill organizer subsystem comprises means for processing project related information on completion of a project comprising processing of project profile and project plan of said project, identification of a plurality of work items of said project, identification of a plurality of knowledge workers assigned to each of said plurality of work items, obtaining a plurality of skills associated with each of said plurality of work items, extraction of field of work, major area, and grade for each of said plurality of knowledge workers of each of said plurality of work items, and consistency verification of skill grade information of each of said plurality of knowledge workers of each of said plurality of work items.

6. The system of claim 1, wherein said skill assessment subsystem comprises means for assessing basic skills of a knowledge worker, wherein said assessment is based on qualification of said knowledge worker, field of study of said knowledge worker, and domain specialization of said knowledge worker, and wherein said assessment comprising determination of qualification, field of study, and grade of said knowledge worker, determination of a skill grade of said knowledge worker based on application of a plurality of rules using qualification, field of study, and grade of said knowledge worker, and consistency verification of said skill grade of said knowledge worker.

7. The system of claim 6, wherein said skill assessment subsystem further comprises means for assessing advanced skills of an experienced knowledge worker, wherein said assessment is based on qualification, field of study, field of work, and references related to said experienced knowledge worker, and said assessment comprising determination of a plurality of work experiences of said experienced knowledge worker, assignment of a weight to each of said plurality of work experiences, determination of a skill grade based on said weight of each of said plurality of work experiences, scaling of said skill grade based on a plurality of referrals, and consistency verification of said skill grade of said experienced knowledge worker.

8. The system of claim 1, wherein said skill evolution subsystem comprises means for incrementally updating skills of a knowledge worker based on working on a project comprising determination of a plurality of major areas of contribution of said knowledge worker in said project, assessment of a skill grade based on a plurality of metrics of said project and a plurality of project end appraisals of said project, consistency verification of said skill grade of said knowledge worker, determination of an overall skill grade using a plurality of skill grades of said knowledge worker based on a plurality of project experiences of said knowledge worker and a plurality of training experiences of said knowledge worker.

9. The system of claim 8, wherein said skill evolution subsystem further comprises means for incrementally updating skills of a knowledge worker based on a training program comprising determination of a plurality of major areas of training of said knowledge worker in said training program, assessment of a skill grade based on a plurality of metrics of said training program and a plurality of training end appraisals of said training program, consistency verification of said skill grade of said knowledge worker, determination of an overall skill grade using a plurality of skill grades of said knowledge worker based on a plurality of project experiences of said knowledge worker and a plurality of training experiences of said knowledge worker.

10. The system of claim 1, wherein said skill matching subsystem comprises means for matching a skill of a knowledge worker with respect to a project specific skill for a period, wherein said matching is based on nearness of said skill and said project specific skill with respect to a skill hierarchy, extent of availability of said knowledge worker during said period, and combined evaluation based on said skill of said knowledge worker, availability of said knowledge worker during said period, said project specific skill, and said skill hierarchy.

11. The system of claim 10, wherein said skill matching subsystem further comprises means for skill matching of a plurality of knowledge workers and a plurality of skills related to a project comprising analyzing said project to determine period and number of resources required with each of said plurality of skills, division of said plurality of skills into a plurality of non-overlapping subsets of said plurality of skills, and near-optimal assignment of a subset of said plurality of knowledge workers to said project based on each of said plurality of non-overlapping subsets.

12. The system of claim 10, wherein said skill matching subsystem further comprises means for iterative skill matching of a plurality of skills, with each of said plurality of skills requiring a plurality of knowledge workers over a distinct period, comprising determination of a plurality of singleton skills based on said plurality of skills with each of said plurality of singleton skills requiring only one knowledge worker, and optimal assignment of a plurality of knowledge workers based on extent of match of a plurality of skills of said plurality of knowledge workers with said plurality of singleton skills, and extent of availability of said plurality of knowledge workers during said distinct period of each of said plurality of singleton skills.

13. The system of claim 10, wherein said skill matching subsystem further comprises means for optimal resource assignment based on a skill matrix and a resource matrix, wherein said skill matrix depicts a plurality of basic skills and a plurality of skills that are nearer to each of said plurality of basic skills with respect to a skill hierarchy, and said resource matrix depicts the availability of a plurality of knowledge workers with respect to said plurality of basic skills, comprising maximization of summation of a plurality of products of each of plurality of elements of said resource matrix with a corresponding element of said skill matrix, ensuring that a knowledge worker is assigned only once, ensuring that number of knowledge workers assigned is equal to the number of distinct skills in said plurality of basic skills, and ensuring that a knowledge worker is either assigned or not assigned.

14. A network based system for skill management comprising:
(a) a plurality of local skill management systems;
(b) a network for interconnecting said plurality of local skill management systems; and
(c) a central skill manager for managing interconnection of said plurality of local skill management systems.

15. The system of claim 14, wherein said central skill manager comprises means for distributed processing of a requirement for a plurality of knowledge workers comprising heuristic based partitioning of said requirement into a plurality of blocks, distributing said plurality of blocks to a plurality of skill management systems, and combining results received from said plurality of skill management systems.
